(19) United States
(12) Patent Application Publication
(10) Pub. No.: US 2026/0244515 A1
(43) Pub. Date: Aug. 20, 2026

(54) SYSTEM AND METHOD FOR EVENT MONITORING AND VISUALIZATION

(71) Applicant: ROYAL BANK OF CANADA, Toronto (CA)

(72) Inventors: Graham Alexander WATT, Toronto (CA); Branko ZDRAVKOVIC, Toronto (CA); Apostolos SCONDRIANIS, Toronto (CA); Ivan Ezekiel De Chavez SUYAT, Calgary (CA); Rahat ISLAM, Calgary (CA); Noureldin Ashraf Mamdouh ABDELLATIF AMER, Calgary (CA); Divyansh GOYAL, Calgary (CA); Nguyen Gia Hy HUYNH, Calgary (CA)

(21) Appl. No.: 19/057,333

(22) Filed: Feb. 19, 2025

(51) Int. Cl. G06F 9/54; G06F 9/451; G06F 16/2458

(52) U.S. Cl. CPC G06F 9/542; G06F 9/452; G06F 16/2458

(57) ABSTRACT

There is provided systems and methods for monitoring and visualizing impacts of events. A list of entities and locations may be obtained. Automated workers may obtain event data from external data sources, including event types and geospatial data defining boundaries of events. A map may be displayed in a graphical user interface which depicts affected entities using superclustering techniques. Different types of events and degrees of severity may be indicated in the renderings.

### FIELD

This disclosure relates to systems and methods for monitoring events, and in particular to monitoring events and determining affected individuals.

### BACKGROUND

As time goes on, extreme weather events and, more generally, acute physical climate risk events, are increasing in both frequency and severity. Understanding the effects of such events (e.g. insured damages from ice storms, fires, floods, and the like) is crucial, as consequences and effects of such events may impact many different people in various different ways.

It may be advantageous and/or helpful to understand how extreme climate risk events may affect individuals at the individual level. At present, there is no automated way of determining which individuals will be affected by a climate risk event, nor of determining what actions might be suitable to assist each particular individual. Multi-member teams of subject matter experts may be convened to perform a tedious and long process to understand climate events, but any resulting analysis would be generalized and reactive in nature.

Accordingly, there is a need for systems and methods which can provide an automated approach for identifying and determining the individuals affected by climate events as these events progress.

### SUMMARY

According to an aspect, there is provided a method of monitoring and visualizing impacts of events, the method comprising: obtaining a list of entities, each of said entities comprising location data; obtaining, by one or more workers, at least one event data object corresponding to an event from at least one data source, said at least one event data object comprising an event type and geospatial data defining boundaries of said event; augmenting said at least one event data object, said augmenting comprising determining, for each of said at least one event data objects, a count of entities affected by said respective event, said determining comprising computing geospatial intersections between said list of entities and said at least one event data object based on said location data and said geospatial data; storing said at least one event data object as a data asset into one of a plurality of collections of stored events within database, each of said collections corresponding to a distinct event type; displaying, in a graphical user interface, a map and a form comprising a plurality of form parameters; sending, via an application programming interface (API), a query to said database based on said form parameters; receiving, responsive to said query, query results comprising geospatial data representing an area of one or more events, and a respective number of said entities affected by each of said one or more events; displaying, in said graphical user interface, a rendering of said areas of said one or more events, each of said areas having a color corresponding to said event type, wherein each of said areas is rendered with a border having a color corresponding to a severity of said respective event.

According to another aspect, there is provided a system comprising: one or more processors; a non-transitory computer-readable storage medium having stored thereon processor-executable instructions that, when executed by said one or more processors, cause said one or more processors to perform a method of monitoring and visualizing impacts of events, the method comprising: obtaining a list of entities, each of said entities comprising location data; obtaining, by one or more workers, at least one event data object corresponding to an event from at least one data source, said at least one event data object comprising an event type and geospatial data defining boundaries of said event; augmenting said at least one event data object, said augmenting comprising determining, for each of said at least one event data objects, a count of entities affected by said respective event, said determining comprising computing geospatial intersections between said list of entities and said at least one event data object based on said location data and said geospatial data; storing said at least one event data object as a data asset into one of a plurality of collections of stored events within database, each of said collections corresponding to a distinct event type; displaying, in a graphical user interface, a map and a form comprising a plurality of form parameters; sending, via an application programming interface (API), a query to said database based on said form parameters; receiving, responsive to said query, query results comprising geospatial data representing an area of one or more events, and a respective number of said entities affected by each of said one or more events; and displaying, in said graphical user interface, a rendering of said areas of said one or more events, each of said areas having a color corresponding to said event type, wherein each of said areas is rendered with a border having a color corresponding to a severity of said respective event.

According to still another aspect, there is provided a computer-readable storage medium having stored thereon computer-executable instructions that, when executed by one or more processors, cause the one or more processors to perform a method of monitoring and visualizing impacts of events, the method comprising: obtaining a list of entities, each of said entities comprising location data; obtaining, by one or more workers, at least one event data object corresponding to an event from at least one data source, said at least one event data object comprising an event type and geospatial data defining boundaries of said event; augmenting said at least one event data object, said augmenting comprising determining, for each of said at least one event data objects, a count of entities affected by said respective event, said determining comprising computing geospatial intersections between said list of entities and said at least one event data object based on said location data and said geospatial data; storing said at least one event data object as a data asset into one of a plurality of collections of stored events within database, each of said collections corresponding to a distinct event type; displaying, in a graphical user interface, a map and a form comprising a plurality of form parameters; sending, via an application programming interface (API), a query to said database based on said form parameters; receiving, responsive to said query, query results comprising geospatial data representing an area of one or more events, and a respective number of said entities affected by each of said one or more events; and displaying, in said graphical user interface, a rendering of said areas of said one or more events, each of said areas having a color corresponding to said event type, wherein each of said areas is rendered with a border having a color corresponding to a severity of said respective event.

Other features will become apparent from the drawings in conjunction with the following description.

### BRIEF DESCRIPTION OF DRAWINGS

In the figures which illustrate example embodiments,

FIG. 1 is a block diagram depicting components of an example computing system;

FIG. 2 is a block diagram depicting components of an example computing device;

FIG. 3 depicts a simplified arrangement of software at computing device;

FIG. 4 depicts a logical arrangement of components of an example event tracking and analysis system, in accordance with some embodiments;

FIG. 5 is a block diagram depicting example components of scheduler, in accordance with some embodiments;

FIG. 6 depicts example contents of a document stored in an example Ready Alerts collection, in accordance with some embodiments;

FIG. 7 is a depiction of an example graphical user interface displaying a map visualization, in accordance some embodiments;

FIG. 8 is a block diagram depicting simplified interoperation between frontend, backend layer, and database and underlying data assets, in accordance with some embodiments;

FIG. 9 is a depiction of an example form within a graphical user interface, in accordance with some embodiments;

FIG. 10 depicts example color coded legends depicting severity of alerts, in accordance with some embodiments;

FIG. 11 depicts an example color coded legend of border color to indicate the number of individuals or clients affected by an event, in accordance with some embodiments;

FIG. 12 depicts an example pop-up graphic, in accordance with some embodiments;

FIG. 13 depicts an example form 750 in which the search option drop-down menu has been set to “Client CSV Upload”, in accordance with some embodiments;

FIG. 14 depicts an example CAP format architecture, in accordance with some embodiments;

FIG. 15 depicts example contents of a CAP alert in XML format, in accordance with some embodiments;

FIG. 16 depicts contents of an example fire event object, in accordance with some embodiments;

FIG. 17 depicts contents of an example client data asset, in accordance with some embodiments;

FIG. 18 depicts contents of an example territorial data asset, in accordance with some embodiments; and

FIG. 19 depicts contents of an example precomputed intersection table, in accordance with some embodiments.

### DETAILED DESCRIPTION

Some embodiments described herein may provide a system configured to provide real-time and/or historical insights into events within a geographical area (e.g. Canada, the USA, or the like) and individuals located within that geographical area. In some embodiments, the system may include an automated data aggregator, a data processor, and a visual analyzer.

Some embodiments may be configured to monitor real-time climate and/or weather events (e.g., fires, floods, and the like), and nationwide and regional alerts from various publicly accessible data sources. When a new event is detected by the system, some embodiments may be configured to identify individuals (e.g., clients of an organization) at risk based on spatial intersections between defined boundaries of the event, and the locations of the individuals. Some embodiments may be configured to analyze thousands of weather events and assess the impact of said weather events on millions of individuals in real-time. In some embodiments, such real-time analysis may facilitate proactive and pre-emptive actions to be identified and performed to help an individual.

In some embodiments, systems and methods described herein may allow an organization (e.g., financial institutions, insurance companies, and the like) to fulfill their regulatory responsibilities in a much more time-efficient and comprehensive manner, at significantly less expense.

For example, in Canada, about 300 evacuation orders per year are issued, and around 500 severe events are observed each year. A team of at least five subject matter experts would be required for each department of an organization to manually monitor all available weather event sources, identify which events are notable and how these events and their geographic boundaries evolve over time, and then identify individuals that are located close to or within the geographical area, collect the individuals' postal codes, and compile a low resolution list of individuals to provide to organization leaders and regulators. Automation of such processes in a manner which is scalable may result in significant cost savings, and improved accuracy in results.

Some embodiments of systems and methods described herein may enable an organization to provide timely, relevant and tailored communications and assistance to individuals affected, which may help to mitigate risks, ensure business continuity, and safeguard the individuals' interests. This may lead to enhanced and personalized client experiences which may create a stronger bond between an organization and an individual who is a client of the organization. Some embodiments may assist an organization in generating revenue by delivering product and marketing offers which are tailored and personalized to individual clients (rather than blanket analysis at a postal code or city level).

Some embodiments developed and experimentally tested were capable of performing spatial intersections with 14 million individual clients of an organization, with thousands of events, in under 10 minutes by using optimized queries. Existing automation systems required about 12 hours to perform a similar analysis. As such, some embodiments described herein represent significant improvements in computation efficiency over existing systems.

Some embodiments described herein may be particularly useful to organizations such as financial service providers. Financial service providers may be obligated or required by regulation to stay up-to-date on all relevant potential risks and events which may have an impact on clients. Some embodiments described herein may provide an end-to-end solution for an organization to provide real-time, accessible, and aggregated information regarding the impact of climate events (e.g., floods, wildfires) on potentially millions of customers throughout a country, region of interest, locations of interest, or any other area.

Financial service providers may have a need to make informed decisions regarding potential risks at client and/or branch locations before, during, and after extreme climate events. For example, a business strategist or portfolio manager might benefit from some embodiments when determining whether issuing a mortgage to a client in an area impacted by major floods is advisable. In another example, a credit specialist might benefit from some embodiments when determining whether to issue a credit card to a client in a region currently affected by wildfires.

In some embodiments, a real-time event monitoring system may include an automated data aggregator, a data processor, and a visual data analyzer. In one example framework, a real-time event monitoring system architecture may include four layers, namely a frontend web application, a backend Application Programming Interface (API) and data processor, a database containing the underlying data asset layer, and a data retrieval unit.

As described below, in some embodiments, the frontend web application may provide a visual tool to users which depicts polygons of alerts and the individuals impacted for each alert by current weather events and/or historical weather events. In some embodiments, the backend API and data processor may provide a layer of access to the underlying database of data assets, which may allow for a standardized way to make calls to the database. In some embodiments, the database containing the underlying data asset layer may store data for one or more of individuals/clients, weather events, and intersections therebetween. In some embodiments, the data retrieval unit may be used to aggregate and/or process data directly form data sources.

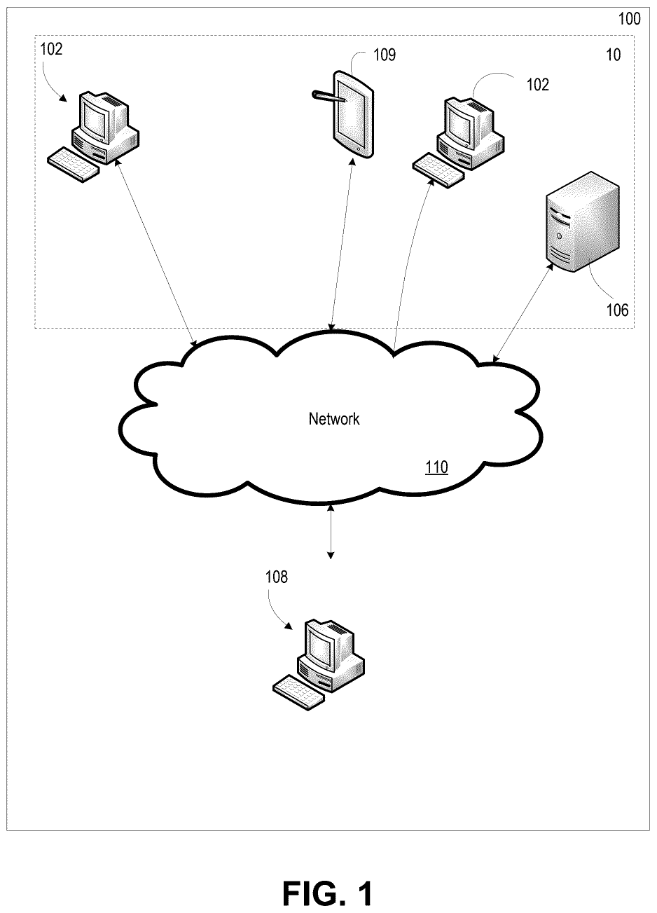

Various embodiments of the present invention may make use of interconnected computer networks and components. FIG. 1 is a block diagram depicting components of an example computing system 100. Components of the computing system are interconnected to define an event tracking and analysis system. As used herein, the term “event tracking and analysis system” refers to a combination of hardware devices configured under control of software and interconnections between such devices and software.

As depicted, the operating environment may include a variety of clients incorporating and/or incorporated into a variety of computing devices which may communicate with other computing devices 102 via one or more networks 110. For example, a client 108 may incorporate and/or be incorporated into a client application implemented at least in part by one or more computing devices. Example computing devices may include, for example, at least one server 102 with a data storage 118 such as a hard drive, array of hard drives, network-accessible storage, or the like; at least one web server 106, and a plurality of client computing devices 108. Server 102, web server 106, and client computing devices 108 may be in communication by way of a network 110. More or fewer of each device are possible relative to the example configuration depicted in FIG. 1. In some embodiments, one or more computing devices may be logically internal to an organization 10 (depicted in FIG. 1 as devices 102, 109 and 106 being internal to organization 10).

Network 110 may include one or more local-area networks or wide-area networks, such as IPv4, IPv6, X.25, IPX compliant, or similar networks, including one or more wired or wireless access points. The networks may include one or more local-area networks (LANs) or wide-area networks (WANs), such as the internet. In some embodiments, the networks are connected with other communications networks, such as GSM/GPRS/3G/4G/LTE/5G networks.

In some embodiments, the computing system 100 may provide access to one or more software applications. In some embodiments, event tracking and analysis system 126 may send and/or receive information, requests and responses to and from third party services external to the organization 10.

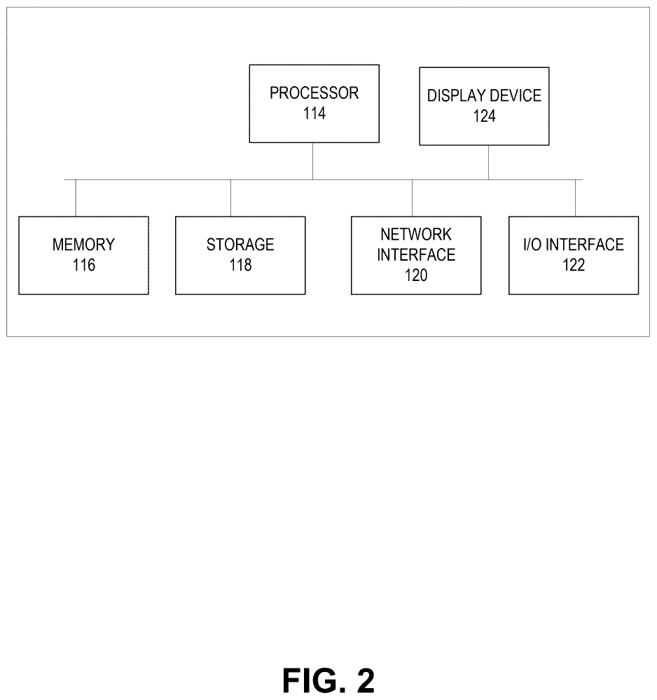

FIG. 2 is a block diagram depicting components of an example computing device, such as a desktop computing device 102, server 108, tablet 109, mobile computing device, and the like. As depicted, an example computing device may include a processor 114, memory 116, persistent storage 118, network interface 120, and input/output interface 122.

Processor 114 may be an Intel or AMD x86 or x64, PowerPC, ARM processor, or the like. Processor 114 may operate under the control of software loaded in memory 116. Network interface 120 connects the computing device to network 110. Network interface 120 may support domain-specific networking protocols for certain peripherals or hardware elements. I/O interface 122 connects the computing device to one or more storage devices and peripherals such as keyboards, mice, pointing devices, USB devices, disc drives, display devices 124, and the like.

In some embodiments, I/O interface 122 may connect various hardware and software devices used in connection with the systems and methods described herein to processor 114 and/or to other computing devices. In some embodiments, I/O interface 122 may be compatible with protocols such as WiFi, Bluetooth, and other communication protocols.

Software may be loaded onto one or more computing devices. Such software may be executed using processor 114.

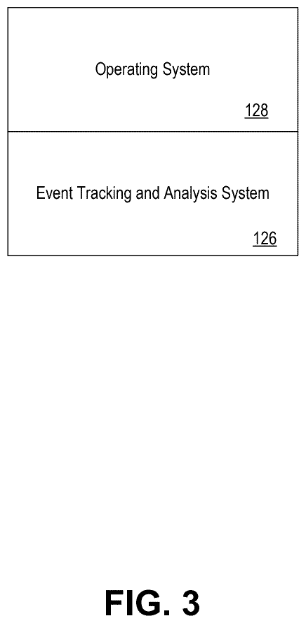

FIG. 3 depicts a simplified arrangement of software at an example computing device. The software may include an operating system 128 and application software, such as event tracking and analysis system 126. It will be appreciated that in some computing environments, such as distributed computing environments, implementation, and administration of a service such as system 126 may be distributed amongst a plurality of separate computing devices within and/or external to an organization 10, and FIG. 3 is intended to depict a simplified logical separation between an operating system 128 and an application executing on one or more computing devices.

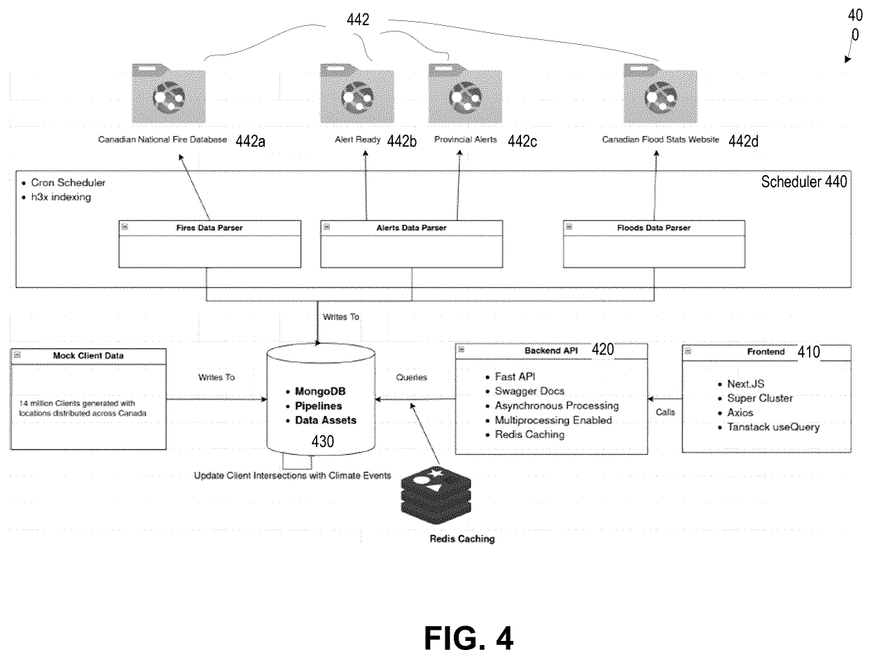

FIG. 4 depicts a logical system architecture diagram for an example event tracking and analysis system 400, in accordance with some embodiments. As depicted, system 400 may include four layers, including frontend 410, backend API 420, database 430, and scheduler 440. In some embodiments, the implementation of each of said layers may be packaged in a separate container (e.g., a Docker container service). In some embodiments, the use of containers may facilitate deployment of system 400 in distributed computing environments, such as cloud computing environments. As depicted, schedule 440 is configured to obtain data from a plurality of sources, which is parsed and written to database 430.

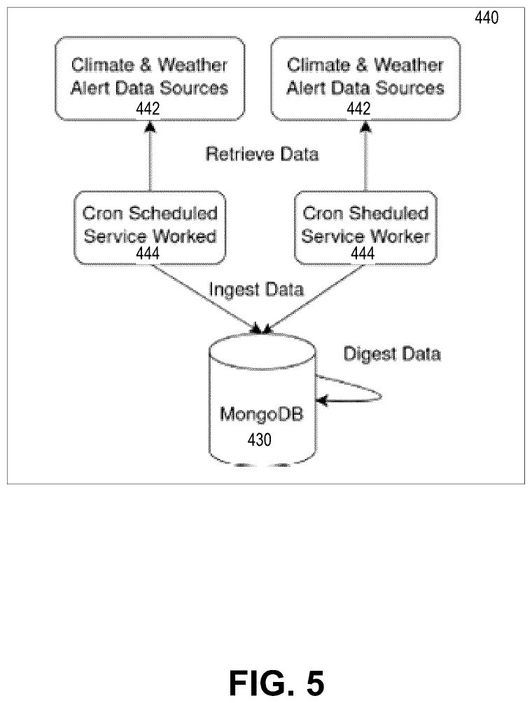

FIG. 5 is a block diagram depicting example components of scheduler 440, in accordance with some embodiments. As depicted, one or more Service Workers 444 are instantiated by schedule 440. In some embodiments, a service worker 444 is a bot or software agent configured to perform pre-configured, simple tasks. In some embodiments, service workers 444 are configured to gather information from climate and/or weather alert data source 442. As depicted in FIG. 4, examples of data sources 442 may include, but are not limited to, one or more of a fire service 442a (e.g., the Canadian National Fire Database), national alert services 442b (e.g., the Alert Ready Canadian national public alerting system), provincial alert devices 442c (e.g., the Ontario Emergency Public Warning System), and flood services 442d (e.g., the Canadian Flood Statistics website).

In some embodiments, data sources 442 may include one or more of:
British Columbia Alerts: Evacuation orders and alerts, and alert archives.
Alberta Emergency Alerts: Emergency notifications for Alberta, vital for regional risk insights and alert archives.
Saskatchewan SaskAlerts: SaskAlert is Saskatchewan's Emergency Public Alerting program used to alert the public in real-time of an emergency situation. The government of Saskatchewan also keeps an archive of past alerts.
Alert Ready: A Canadian nationwide alert system that ensures comprehensive and coordinated emergency information.
Active Floods in Canada: Sourced from the Open Government Portal, this provides data for flood risk assessment across Canada, and both active and historical flood information is available.
Canadian Wildfire Database: Provides active fire perimeters and hotspot fires, as well as historical data for fires are gathered from the Canadian Wildland Information System.

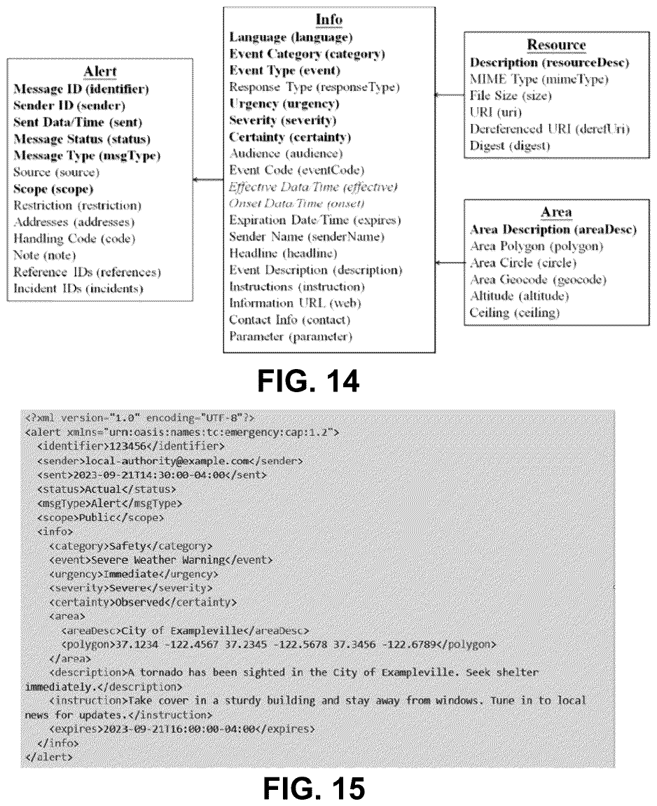

In some embodiments, data sources 442 may use the Common Alerting Protocol (CAP), which is a digital format for exchanging emergency alerts, thereby allowing consistently formatted alert messages to be disseminated over many different communication systems. The CAP standard is used internationally for emergency alerting and public warning, and therefore may provide predictable formatting for alert data for ingestion into database 430. The CAP format may provide key information, such as the nature of the emergency, the urgency of the emergency, the severity of the emergency, and the level of certainty regarding the emergency. CAP data may also include suggestions for appropriate protective/mitigating action, provide geographic coordinates of the affected area, and/or provide a timeframe for the alert/emergency. FIG. 14 depicts an example CAP format architecture. FIG. 15 depicts example contents of a CAP alert in XML format.

In some embodiments, data retrieved by workers 444 may be processed or transformed prior to storage in database 430 as data assets. In some embodiments, database 430 is a MongoDB No-SQL database system. In some embodiments, database 430 may be located internally within an organization 10. In some embodiments, data transformation may be performed using one or more of scripts (e.g., Python scripts) and/or database operations (e.g., MongoDB operations, in embodiments in which database 430 is a MongoDB database). In some embodiments, the underlying data assets of database 430 may be accessed through one or more of API calls, front end 410, and/or directly from database 430 using queries.

In some embodiments, workers 444 may be implemented as Cron service workers, which may allow users to schedule tasks (e.g. commands or scripts) to run at set times, dates, and/or intervals. In some embodiments, Cron jobs are scheduled tasks on Unix-like operating systems that run at specified intervals, automating repetitive tasks such as backups, updates, and data processing. In particular, the Cron utility is useful for repetitive tasks, such as downloading files from the internet at periodic intervals. In some embodiments, service workers 444 may be deployed in a containerized environment (e.g., within scheduler 440) and assigned the task of retrieving event data from various data sources 442. In some embodiments, data sources 442 may include one or more of provincial alert sources, the Alert Ready National Public Alerting system, the Canadian Wildland Fire Information System, and the Canadian Floods Stat database. It is contemplated that alert, fire and flood services in other jurisdictions may also be used, depending on the geographic region of interest.

In some embodiments, service workers 444 may be configured to use a Really Simple Syndication (RSS) feed to retrieve data. In some embodiments, workers 444 may be configured to retrieve newly uploaded data at a set interval. For example, in some embodiments, workers 444 may be configured to extract information from data sources 442 at 15 minute intervals. In this manner, the underlying data assets within database 430 may be kept up-to-date.

In some embodiments, the data provided by data sources 442 may be formatted as shape files and/or extensible markup language (XML) files. In some embodiments, workers 444 may be configured to extract data from shape files and/or XML files. As new events are made available at data sources 442, workers 444 are configured to inspect, clean, analyze, and/or transform the event data into a format suitable for ingestion into database 430 (e.g., data may be transformed to a format suitable for a MongoDB database).

In some embodiments, data transformations (also referred to herein as augmentations) made to event data may include, and is not limited to, the indexing of geospatial data pertaining to an event into the H3 index format (or other suitable geospatial index), the selection of subsets of available data fields for each event that are of interest to the organization for a particular event type, the removal of duplicate events, and/or the computation of the count of affected individuals and/or clients by each event.

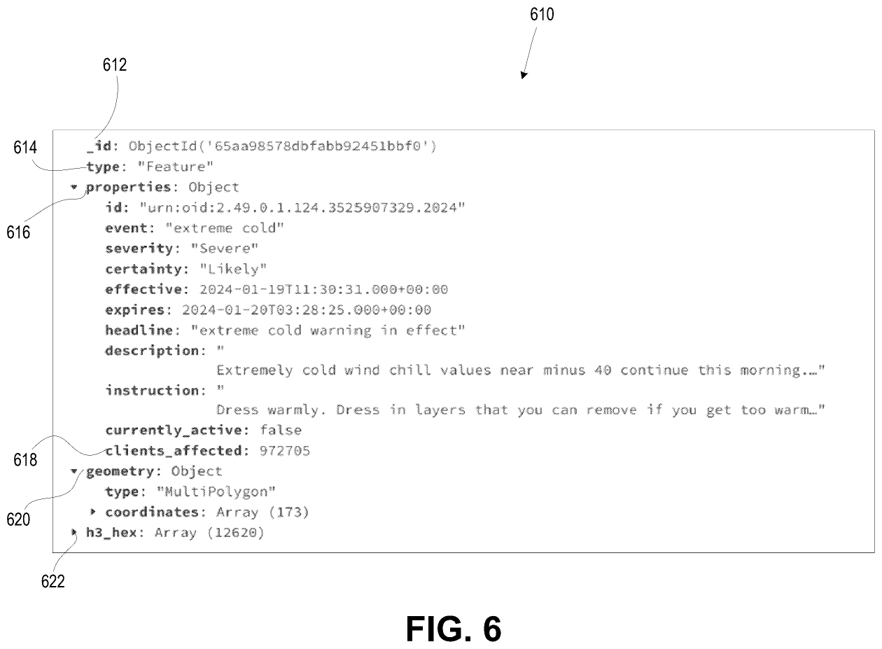

In some embodiments, each type of event is stored in a MongoDB collection. In some embodiments, each event is stored as a unique document within its corresponding collection. FIG. 6 depicts example contents of a document 610 stored in an example Ready Alerts collection. As depicted, document 610 includes a unique identifier 612 (depicted as “_id”) which is assigned to each new file added to the MongoDB collection. Document 610 may further include a type attribute 614, which identifies the type of geometric object associated with document 610. In this example embodiment, the type attribute is “feature”, which refers to geometric objects which have additional properties 616.

In some embodiments, additional properties 616 may include a subset (or all) of fields extracted from Alert Ready data which are of interest to organization 10. In some embodiments, properties 616 may include at least one of an identifier, an event type, a severity description, a certainty level, an event duration, an event expiration, a headline, an event description, an event instruction, and an active status Boolean value. As depicted, properties 616 may further include determinations not obtained from data source 442, such as “clients_affected” 618, which represents the number of clients of organization 10 who are affected by the event corresponding to document 610.

In some embodiments, document 610 may further include a geometry field 620, which may contain a definition of the geographic boundaries of the alert for the event to which document 610 corresponds. In some embodiments, document 610 may further include an h3_hex value, which contains the H3 hierarchical geospatial index information of the alert's geometry.

It should be appreciated that document 610 represents an example embodiment of a document corresponding to a particular type of event (e.g. extreme cold). It is contemplated that different types of events may be stored using a similar file contents structure, but may include different properties 616 data fields which are of interest. For example, a fire alert might include properties 616 such as wind speed and wind direction.

In some embodiments, once event data has been extracted and stored in database 430, a data processing stage begins. In the data processing stage, workers 444 may be configured to initiate scripts that process information stored in database 430. In some embodiments, scripts may include operations such as querying database 430. In some embodiments, queries may use customized aggregation pipelines to improve or optimize data processing. For example, in some embodiments, a query may be tailored for processing documents 610 within a particular MongoDB collection pertaining to a particular type of event.

In some embodiments, the first stage of the aggregation pipelines is to perform geospatial intersections between the geometries 620, 622 of stored events and the geometries of a stored list of individuals or clients. In some embodiments using a MongoDB database 430, geospatial intersections may be performed using the “$geoIntersects” operator which is a built-in functionality of MongoDB.

In some embodiments, geospatial intersections may be computed using H3 geospatial indexing data. It has been found that as the amount of underlying data assets increases, the use of H3 geospatial indexing data for determining intersections results in significant improvements in processing time. As such, in some embodiments, the stored list of individuals or clients may include, for each individual or client, a pre-computed H3 index based on the individual or client's location as defined by longitude and latitude. In some embodiments, when a new individual or client file is added to database 430, a location defined using H3 indexing may be calculated. The pre-computing of H3 indexing data for individuals/clients may result in faster and more efficient performance when determining intersections between events and individuals/clients.

In some embodiments, the second stage of the aggregation pipelines is to appropriately format the results of the geospatial intersection processing. For example, results may be formatted to match the format used by a particular system. When the second stage of the aggregation pipeline is complete, document 610 may be considered to be ready for insertion in to the appropriate collection in database 430 for use as part of the systems' underlying data assets.

In some embodiments, the final stage of the aggregation pipeline may be the insertion of the geospatial intersection results into pre-existing collections on database 430. In some embodiments, the computations of documents 610 may be performed exclusively within a MongoDB instance, thereby fully utilizing the capabilities of MongoDB for multiprocessing and parallelism that are natively supported. By performing computations within a MongoDB instance, this may ensure that system 400 may be capable of horizontal scaling in the future if and when additional MongoDB instances are instantiated.

In some embodiments, the aggregation pipelines supported by MongoDB may streamline data analysis by enabling the construction of complex workflows for processing and transforming data directly within database 430. In some embodiments, MongoDB pipelines support a diverse range of operations, including filtering, grouping, and statistical computations, which may provide efficiency and scalability. In experimental testing of some embodiments, the use of aggregation pipelines resulted in precomputed data tables being processed in 10 minutes, relative to 5 hours using conventional queries for the same task. Thus, aggregation pipelines in MongoDB may offer substantial improvements in performance.

In some embodiments, the computation cycle of extracting information from data sources 442, creating documents 610, and performing geospatial intersections may require a certain amount of time (e.g., 7.5 to 8 minutes). In some embodiments, the interval between periodic updates by workers 444 may be set to be longer than the amount of time required to extract, create documents, and preform geospatial intersections. In an example embodiment, the interval may be set to 15 minutes, thereby allowing for a 6-7 minute buffer between each computation cycle. Such a configuration has been confirmed experimentally to provide a sufficient buffer to account for variations in computation cycles, as well as an expanding dataset of stored events.

Advantageously, the timeframe required for a computation cycle may be reduced through the instantiation and deployment of additional instances of the MongoDB database (e.g., in a cluster computing environment).

In some embodiments, the data assets of database 430 may be accessed through one or more of an API layer (e.g., backend 420), frontend 410, and directly from the database 430 using queries. The use of APIs to access data assets may provide numerous benefits, including increased integration speed, improved security, improved flexibility, and improved scalability. Moreover, the use of an API facilitates access to information for users who lack technical knowledge and sophistication. In some embodiments, frontend 410 may provide a visualization (e.g. a graphical representation in a graphical user interface (GUI)) of the core functionalities that the backend API layer 420 provides. In some embodiments, frontend 410 may provide direct access to the underlying data assets of database 430, which may enable data access tailored to specific use cases.

Returning to FIG. 4, system 400 includes backend layer 420 (depicted as backend API 420 in FIG. 4). In some embodiments, a main purpose of the backend 420 is to service multiple users within an organization concurrently while processing a large amount of data in parallel. Due to the significant volumes of data which could be involve din some embodiments, it is important that backend 420 provides a robust and comprehensive structured system in which to interact with the underlying data assets of the system, and perform the computations to meet requirements. In some embodiments, the use of an API layer with backend 420 may allow for backend 420 to more easily integrate with external systems, and provide an interface for data asset access to users irrespective of a user's level of technical knowledge.

In some embodiments, backend API 420 may be deployed over a Gunicorn HTTP server. Gunicorn HTTP servers may be particularly useful for enhancing scalability, relative to other HTTP servers (such as, e.g., uvicorn). Moreover, Gunicorn's capability to manage multiple worker processes may allow for more efficient handling of concurrent requests which may result in faster response times and more efficient resource utilization.

As depicted in FIG. 4, in some embodiments, backend API 420 may be integrated with Redis for caching, and with MongoDB. In some embodiments, an asynchronous client (e.g., MotorIO) may be used when connecting to MongoDB. The use of asynchronous operations may improve the overall API performance in some embodiments, and particularly when under high processing loads. The use of asynchronous operations may also facilitate a greater degree of utilization of hardware, by performing extensive parallel operations asynchronously, thereby leading to a reduction in processing time.

In some embodiments, the backend API 420 is implemented using FastAPI. FastAPI is a web framework for building APIs in the Python language which is based on Starlette for the web component, and Pydantic for data validation and serialization components. Although other types of APIs are contemplated, the FastAPI framework may be particularly suitable in some embodiments, due to its high performance, ease of use, automatic documentation, and extensibility. In particular, FastAPI uses asynchronous programming to achieve high performance, which makes it suitable for handling high processing loads and concurrent requests. FastAPI also uses a clean and concise syntax which allows developers to quickly build and deploy APIs. Advantageously, FastAPI automatically generates interactive API documentation, based on the Python type hints used in the code. Such documentation may include input validation, response models, and the like, making it easier for developers to understand and use the API. Finally, FastAPI is highly extensible, with support for middleware, custom validators, response formats, and the like, allowing the framework to be more tailored to system 400's specific needs.

In some embodiments, backend 420 is decoupled and modular, so as to promote flexibility, maintainability, and scalability. In some embodiments, backend 420 includes routers and controllers (also referred to herein as “operations”). In some embodiments, routers create API endpoints, validate incoming requests, and/or pass incoming requests to controllers. In some embodiments, controllers perform database queries.

In some embodiments, routers are components of backend 420 which receive a remote procedure call (RPC) when an endpoint is called. Since endpoint requests are typically originating outside of the API, routers are configured to validate endpoint requests and the body of the endpoint requests. For example, if an endpoint request requires a certain type of data field included as an input, a router is configured to validate that the endpoint request contains the correct input prior to performing operations. This may aid in avoiding errors and undefined behaviors from the API.

In some embodiments, routers may include one or more validators, which are subcomponents of routers. In some embodiments, a validator module may be called by a router to ensure an API endpoint request is valid. In some embodiments, validation operations may be abstracted from the router components, so as to allow more modularity and reduce code repetition.

In some embodiments, routers may be configured to ensure that responses to API endpoint requests are returned in the correct format prior to being sent to the requester (e.g., the user). Data may be returned in the JSON and CSV formats. In some embodiments, the JSON format may be used by frontend 410 when the frontend makes API calls and expects a response in one batch. In some embodiments, CSV formatted data streams may be used in instances in which the response to an API call is not sent all at once. In some embodiments, system 400 is configured to allow users to download results to a query as a CSV file in the background, which enables the use of streaming responses.

In some embodiments, streaming responses may be facilitated through the use of StringIO streams, which are a form of in-memory stream for text supported by the Python library. In some embodiments, stringIO streams may be used to store CSV data into an object, and that object may be sent to the user while the request is still being processed. Advantageously, CSV files may be sent to the user without first locally saving the files prior to sending the files. In some embodiments, backend API 420 may be stateless, and therefore avoiding the need to download and save files avoids potential issues concerning data integrity.

In some embodiments, operations (or controllers) are the component of backend API layer 420 which perform the majority of logical operations. After a backend API request has been validated, the request is sent from the route to a controller component. In some embodiments, the controller is configured to query the database 430 and return the results of the query to the router. In some embodiments, the database 430 may be implemented using MongoDB and/or Redis.

In some embodiments, controllers use asynchronous programming when interacting with database 430. The use of MongoDB aggregation functions may significantly improve the speed of database queries, which in turn improves the API's responsiveness to queries. In some embodiments, the results of queries may be cached (e.g. in Redis cache, as depicted in FIG. 4). Thus, if a subsequent query is received (e.g., from a different user) which is the same or substantially similar to an already-received-and-processed query, the results may be retrieved from the cache and returned quickly (relative to the time required to perform a query). Further example embodiments quantifying performance gains are described in detail below.

In some embodiments, controllers are configured to handle data in one or more of the JSON and CSV formats. This may help to ensure that the results of queries are compatible with either JSON or CSV formats, depending on which format the original endpoint API request contained.

In some embodiments, backend API 420 provides a plurality of endpoints that provide access to underlying data assets of database 430. In some embodiments, backend API 420 is configured to receive and perform custom batch processing. In some embodiments, the plurality of endpoints comprises 31 end points. In some embodiments, endpoints may relate to one or more of events, alerts, client impacts, area impacts, and file uploads. In the some embodiments, the endpoints may be classified into 7 categories, namely: 1) fire events, 2) flood events, 3) Alert Ready alerts, 4) provincial alerts, 5) client impact, 6) area impact, and 7) CSV file upload.

In some embodiments, fire event endpoints may include:
/fires/activeFirePerimeters: Retrieves a comprehensive list of all currently active fire perimeters. The data may be returned in GeoJSON format. Each item in the returned ‘FeatureCollection’ may correspond to an active fire perimeter, sourced from the ‘activeFirePerimeters’ database collection.
/fires/activeFires: Retrieves a comprehensive list of all currently active fire points. The data may be returned in GeoJSON format. Each item in the returned ‘FeatureCollection’ may correspond to an active fire hotspot, sourced from the ‘activeFires’ database collection.
/fires/firePerimeters: Retrieves a comprehensive list of all fire perimeters in the current season to date. The data may be returned in GeoJSON format. Each item in the returned ‘FeatureCollection’ may correspond to a fire perimeter, sourced from the ‘firePerimeters’ database collection.
/fires/firePerimetersByDate: Returns a comprehensive list of all fire perimeters that fall within the selected dates by the user.
/fires/fireDangers: Retrieves a comprehensive list of all fire danger perimeters which are normally updated several times a day. The data may be returned in GeoJSON format. Each item in the returned ‘FeatureCollection’ may correspond to a fire danger perimeter, sourced from the ‘fireDanger’ database collection.
/fires/fire_id/: Retrieves a list of clients impacted by a specific fire event, identified by a unique Fire ID. This endpoint may use GeoJSON data associated with the fire event to analyze and determine the affected clients based on their geographical location and proximity to the event. The response may include one or more of details such as client IDs, level of impact, and/or relevant client information for effective response and support.
/fires/fireIntersectionsByDate: Retrieves data from the Fire Intersections underlying data asset for fires that took place between two user-entered dates. The response may include a list of clients impacted by each fire within the dates.
/fires/allClientsIntersections: Returns all the intersections for fires (the whole data asset layer with every field)

In some embodiments, flood endpoints may include:
/floods: Returns all flood alerts from the database 430.
/floods/ByDate: Returns all flood alerts from the database based on a specified date range.
/floods/active: Returns floods that are currently active.
/floods/id: Returns a list of all the clients impacted by a certain flood, specified by the flood identifier.
/floods/allClientsIntersections: Returns all the intersections for floods (the whole data asset layer with every field).
/floods/floodintersectionsByDate: Retrieves data from the Flood Intersections underlying data asset for floods that took place between two user-entered dates. The response may include a list of clients impacted by each flood within the dates.

In some embodiments, Alert Ready endpoints may include:
/alerts/: Returns all AlertReady alerts.
/alerts/active: This endpoint returns all AlertReady alerts currently active.
/alerts/byDate: This endpoint returns all AlertReady alerts in the specified time period.
/alerts/id: Return a list of all the clients impacted by a certain alert, specified by the alert id.
/alerts/alertintersectionsByDate: Retrieves data from the AlertReady Alert Intersections underlying data asset for alerts that took place between two user-entered dates. The response may include a list of clients impacted by each alert within the dates.
/alerts/allClientsIntersections: Returns all the intersections for AlertReady alerts (the whole data asset layer with every field).

In some embodiments, client impact endpoints may include:
/clientimpact/client_id: Retrieves geoJSON formatted data of all disasters intersecting with a specific client's geographical location. The endpoint may accept a client ID and may use the associated client's geographical data to query the disasters' collections. The endpoint may also contains an “active” boolean parameter and start and end date parameters. When the active parameter is set to true, only the active disasters may be returned. When the active parameter is set to false, the disasters active within the specified time frame are returned.

In some embodiments, area impact endpoints may include:
/area-impact/: Analyzes a specified geographic area, defined by user-provided GeoJSON, to identify clients and disasters intersecting within this area. /area-impact may allow filtering of disaster types through flags corresponding to MongoDB collections, such as “firePerimeters” for fire data, “floodAlerts” for flood alerts, “alertReadyOriginalAlertsOnly” for Alert Ready alerts, and “provincialAlerts” for provincial alerts. The endpoint may return GeoJSON data of clients affected by the selected disaster types within the defined area, aiding in targeted disaster response planning, along with GeoJSON of disaster polygons that intersect with the specified geographic area.
/area-impact/locationSearch: Similar to the/area-impact/endpoint, this function targets disaster impact analysis but simplifies the process by allowing users to specify a territory or boundary, such as province (e.g., AB, BC) or postal code, instead of a GeoJSON area. The backend 420 may convert these location identifiers into GeoJSON, facilitating the same comprehensive search for intersections between clients and disasters within the specified location. In some embodiments, users may filter disaster types using flags that map to MongoDB collections, such as “firePerimeters” for fires and “floodAlerts” for floods. The/area-impact/locationSearch endpoint may return GeoJSON data comprising clients impacted by the selected disasters within the designated province or postal code.

In some embodiments, CSV file upload endpoints may include:
/csv_impacts/: This endpoint may accept an input CSV file with one or more of the following column headers: client_id, lat, long, address. This endpoint analyzes the intersection of these locations with either currently active events or with events active within a specific time duration.
/csv_impacts/cache/: Using a cache key, this endpoint may enable a user to obtain a previously submitted or uploaded CSV's results in either JSON or CSV format.

As noted above, backend API 420 is configured to receive API endpoint calls from frontend 410. In some embodiments, frontend layer 410 is implemented as a full stack application. In some embodiments, frontend layer 410 is a web application. Frontend 410 may be configured to showcase the core functionalities of backend 420. In some embodiments, frontend 410 may provide a visualization tool of the overall system 400 (e.g., a graphical user interface) to users.

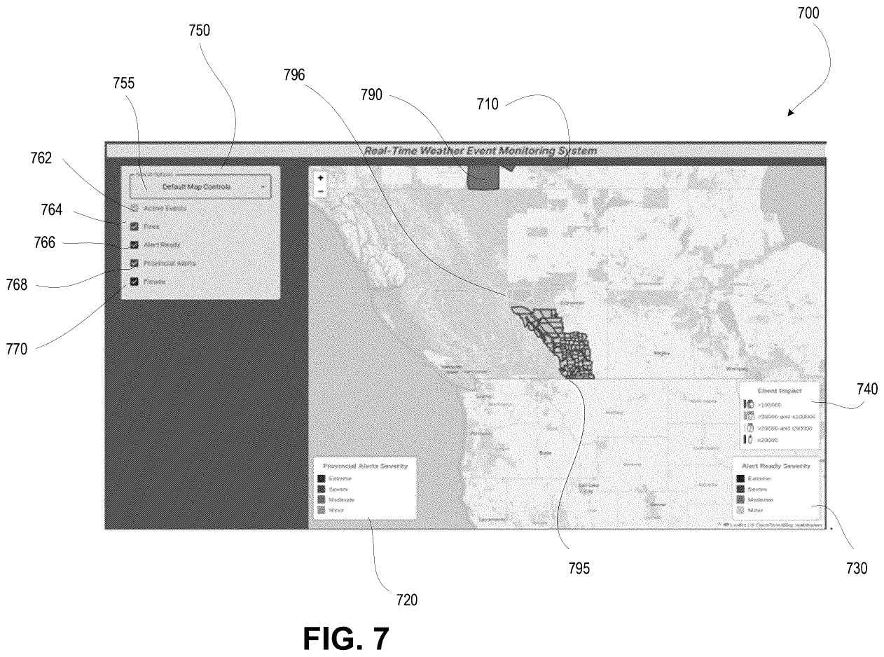

In some embodiments, frontend 410 incorporates, but is not limited to, a combination of NextJS (a Javascript-based framework) and React-Leaflet (an open-source library used to create maps). In some embodiments, frontend 410 is configured to generate and view a map, and/or allows for interaction with a displayed map. FIG. 7 is a depiction of an example graphical user interface 700 displaying a map 710, in accordance some embodiments.

In some embodiments, frontend 410 is configured to collect input from users through one or more of selectors, checkboxes, text fields, and/or buttons within the GUI 700. The collected input may be converted to one or more requests (e.g. API endpoint requests) which are sent to backend API layer 420. Backend layer 420 then validates the request and performs the requested operations, and returns received information to the requesting user at frontend 410.

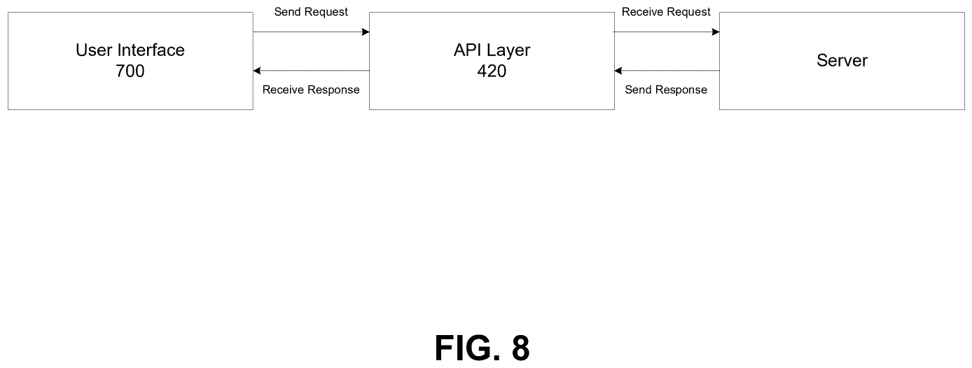

FIG. 8 is a block diagram depicting simplified interoperation between frontend 410, backend layer 420, and database 430 and underlying data assets. As depicted, data is collected from user actions at user interface 700 by frontend 410, which transmits a request to backend layer 420. After validating the request, backend 420 sends a request in the form of one or more API calls to a server configured to access database 430 and the underlying data assets. Backend layer 420 then receives a response from server 430, and sends the response to frontend 410 for consumption and/or display in the GUI 700.

In some embodiments, system 400 may be configured to display a web application in GUI 700 which includes a map of all or a portion of a territory (e.g., Canada) upon which all the currently active events are rendered. FIG. 7 depicts an example interface containing a map 710 for which events in the province of Alberta are displayed, and form selector 750.

As depicted, form selector includes a drop-down menu 755 which includes a plurality of search options. In some embodiments, search options include one or more of: “default map controls”, “by coordinates”, “by client ID”, “by geographical location”, and “Client CSV upload”. GUI 700 further includes a plurality of checkboxes, corresponding to active events 762, fires 764, alert ready 766, provincial alerts 768, and floods 770. It will be appreciated that FIG. 7 depicts an example embodiment, and that other embodiments are contemplated in which one or more checkboxes are omitted, one or more checkboxes are for jurisdictions other than Canada (e.g., states, regions, and the like).

As depicted, active checkbox 762 instructs the form 750 to make either active or historical searches for events based on whether active checkbox 762 is selected or not. Checkboxes 764, 766, 768, 770 may be used to instruct frontend 410 whether to display that type of event. If a checkbox is selected, then that type of event will be included on map 710.

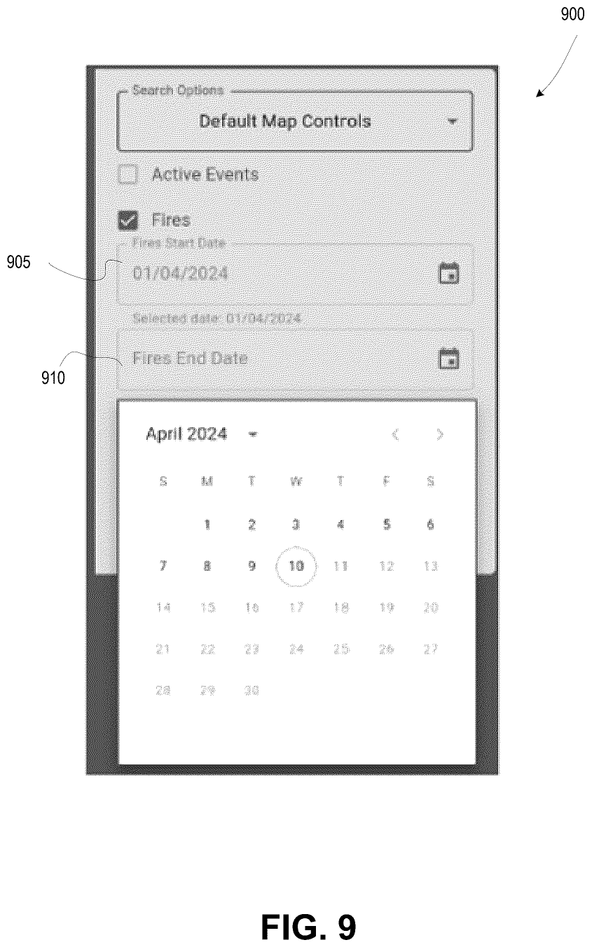

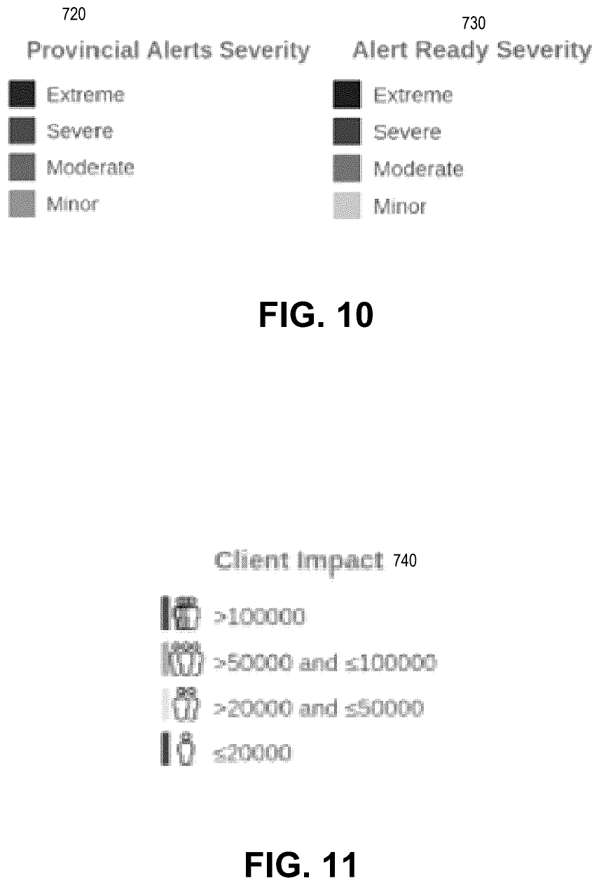

In some embodiments, frontend 410 may monitor the status of active checkbox 762. In some embodiments, when the active checkbox 762 is de-selected, form 750 may automatically display start date and end date fields which can be used to select the time frame of interest. An example form 900 is depicted in FIG. 9.

In some embodiments, frontend 410 monitors the status of checkboxes 764, 766, 768, 770. For example, when a user selects flood checkbox 770, map 710 may be updated automatically to depict flood event data. Likewise, in some embodiments, when a user de-selects a checkbox (e.g., flood checkbox 770), map 710 may be updated automatically to remove flood event graphics. It will be appreciated that the automatic updating may apply for one or more of checkboxes 764, 766, 768, 770. For example, frontend 410 may be configured to monitor whether a start date 905 value or end date 910 has been modified by a user, and automatically perform the appropriate API calls to backend 420 to update the map 710 to reflect the modification.

As depicted in FIG. 7, in some embodiments, each event on map 710 may be represented with a different color. In some embodiments, events on map 710 may be represented as a multi-polygon with a different color. In an example embodiment, system 400 is configured to display four different types of events on map 710: fires, floods, Alert Ready alerts, and provincial alerts. In some embodiments, fires may be depicted with red. In some embodiments, floods may be depicted with blue. In some embodiments, Alert Ready alerts may be depicted with purple. In some embodiments, provincial alerts may be depicted using green.

In some embodiments, the shade or intensity of a given color may be used to indicate the degree of severity. In some embodiments, severity may be subdivided into 4 categories: minor, moderate, severe, and extreme. It will be appreciated that this is merely an example embodiment, and that other methods may be used to indicate severity (e.g. number ranges, normalized number ranges, more than 4 degrees of severity, less than 4 degrees of severity, and the like). For example, as depicted in legend 720 (also shown in FIG. 10), a minor provincial alert might be depicted using an emerald green shade, whereas a severe or extreme provincial alert might be depicted using a darker shade of green.

Likewise, as depicted in legend 730, a minor Alert Ready alert might be depicted using a light shade of magenta, whereas a severe or extreme Alert Ready alert might use an increasingly dark shade of purple.

In some embodiments, the number of individuals (or clients of an organization) can be indicated within map 710. In some embodiments, the borders of the multi-polygons depicting an alert can be rendered using a different color. As depicted in client impact legend 740, an example color scheme might use green to indicate that less than 20,000 clients (or individuals, or otherwise members of a grouping) are affected. In an example color scheme, yellow might be used to indicate that more than 20,000 clients but less than 50,000 clients are affected. In an example color scheme, orange might be used to indicate that more than 50,000 clients but less than 100,000 clients are affected. In an example color scheme, red might be used to indicate that more than 100,000 clients are affected.

Returning to FIG. 7, area 790 depicts a region with a purple shade corresponding to a moderate Alert Ready alert, with a green border which corresponds to fewer than 20,000 clients affected. Area 795 depicts a plurality of regions in Alberta having a shade of purple corresponding to a minor Alert Ready severity, with a red border which corresponds to greater than 100,000 clients affected. Finally, area 796 depicts a plurality of regions in Alberta having a yellow border, corresponding to between 20,000 and 50,000 clients affected.

It will be appreciated that the choice of colors, border colors, and client impact threshold numbers can be adjusted to suit the needs of the end user and that FIG. 7 depicts merely an example embodiment.

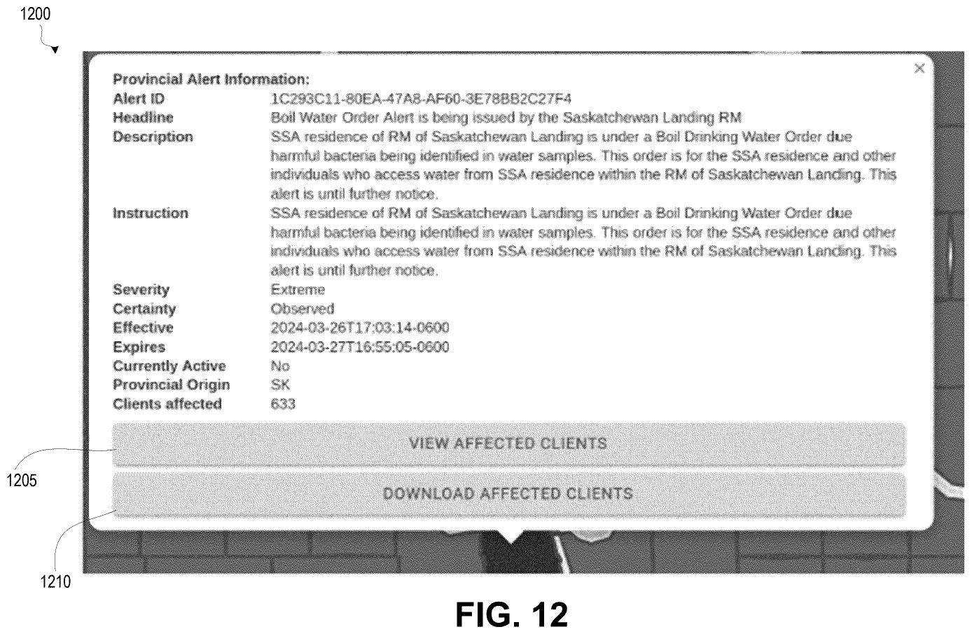

In some embodiments, a popup graphic may appear when the user selects (e.g., clicks) a polygon on map 710. FIG. 12 depicts an example pop-up graphic, in accordance with some embodiments. As depicted, pop-up graphic 1200 contains information describing the event. In some embodiments, graphic 1200 may include a “view affected clients” button 1205 and/or a “download affected clients” button 1210.

As depicted in FIG. 12, the pop-up graphic 1200 relates to a boil water order alert having been issued for an area in Saskatchewan due to harmful bacteria having been identified in water samples, having a severity of “extreme”.

In some embodiments, selecting the “view affected clients” button 1205 causes system 400 to display the locations of all affected clients on map 710. In some embodiments, frontend 410 may invoke the supercluster Javascript library, which can efficiently render millions of clients on frontend 410 without any performance degradation. The use of superclustering may enhance the performance of frontend 410 by efficiently clustering large numbers of markers (rather than attempting to illustrate millions of data points on a map), which both improves rendering speed and overall user experience.

In some embodiments, selecting the “download affected clients” button 1210 causes system 400 to generate a list of affected clients (and associated client information). In some embodiments, the list of affect clients may be embodied as a CSV formatted file.

As described above, it can be seen that frontend 410 may provide the end user (e.g., an employee of an organization) with the ability to visualize active and historical events across a given country or region, together with the impact of the events on locations of interest (e.g., the locations of clients of the organization, the location of branches of the organization, or the like). Moreover, some embodiments of frontend 410 may enable the end user to download data regarding affected individuals (e.g., client data) in the format of a CSV file. It will be appreciated that in other embodiments, it is contemplated that other file formats than CSV (comma separated values) may be chosen.

As described above, in some embodiments, the search options drop down menu 755 may provide a plurality of different visualization search options. In some embodiments, the plurality of visualization search options includes “default map controls”, “by coordinates”, “by client ID”, and “by geographical location”.

In some embodiments, the default map control option may be used to view active or historical events on map 710. In some embodiments, the “by coordinates” option may allow the end user to enter a specific longitude and latitude, and view the events that currently and/or historically have affected that location on map 710. In some embodiments, the “by client ID” option may be used to view how a particular client or individual is impacted by active or historical events. In some embodiments, the “by geographical location” option allows the end user to search active or historical events that impact one or more of a country, province, territory, region, postal code, or the like.

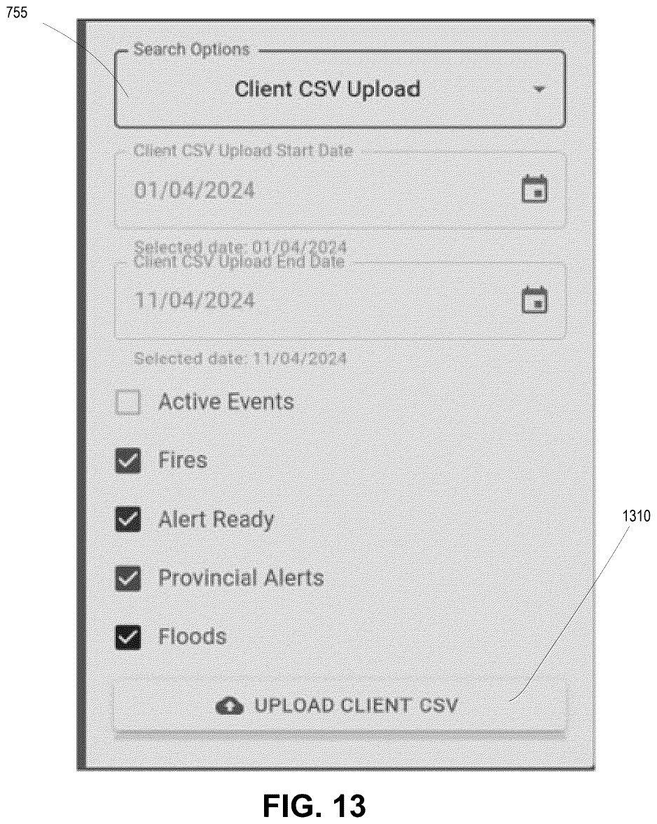

In some embodiments, form 750 may include client data upload functionality. FIG. 13 depicts an example form 750 in which the search option drop-down menu has been set to “Client CSV Upload”. In some embodiments, an upload button 1310 may be generated in form 750 when the “Client CSV Upload” setting is selected. In some embodiments, the client CSV upload feature is configured to access the batch processing functionality of backend 420 for use via frontend 410. In some embodiments, an end user can upload or otherwise submit a CSV file which contains locations of interest, or clients or lists of clients within database 430, and return a file that contains a list of events that each location of interest and/or client is currently impacted by, or has been historically impacted by. A user may access the CSV upload functionality by selecting button 1310, and selecting a CSV file for batch processing.

Returning to FIG. 4, database layer 430 interoperates with frontend 410, backend 420 and scheduler 440. In some embodiments, database 430 is implemented using MongoDB. MongoDB is a NoSQL database management system which offers flexibility, scalability, and ease of use. MongoDB may be particularly suitable for handling the large volumes of data and traffic loads which will be present in some embodiments. Moreover, MongoDB provides native support for sharding, which allows can be used to improve performance and reliability when system 400 is deployed. However, it will be appreciated that it is contemplated that other types of database implementations can be used, depending on the particular use case.

In some embodiments, MongoDB systems include built-in support for geospatial capabilities, which allows for the efficient storage, query and analysis of geospatial data. Moreover, MongoDB systems include built-in replication capabilities to ensure high availability and fault tolerance, with support for sharding to scale horizontally across multiple instances. MongoDB systems also include a built-in framework for aggregation, which can improve query performance by using local or remote MongoDB instances to their full potential.

In some embodiments, built-in geospatial capabilities in MongoDB include: geospatial indexing, queries, data types, 2D and 2D Sphere Indeces, geospatial aggregation operators, and geospatial data import/export.

Geospatial Indexes: MongoDB supports indexing of geospatial data, enabling efficient querying based on spatial criteria. Users can create geospatial indexes on specific fields containing geospatial data, such as coordinates (longitude, latitude), to improve query performance.

Geospatial Queries: MongoDB provides various query operators and methods for performing geospatial queries.

Geospatial Data Types: MongoDB supports two main types of geospatial data: Point and Polygon. In some embodiments, point data represents a single point on the Earth's surface, defined by its longitude and latitude coordinates. In some embodiments, polygon data represents a closed shape consisting of multiple connected points, defining an area on the Earth's surface.

2D and 2D Sphere Indeces: MongoDB supports both planar (flat) and spherical (curved) indexing and querying for geospatial data. This may allow developers to work with data on a flat plane or consider the curvature of the Earth's surface when calculating distances and areas.

Geospatial Aggregation Operators: MongoDB's aggregation framework may include geospatial aggregation operators for performing spatial analysis. These operators allow developers to perform complex geospatial operations within aggregation pipelines. In some embodiments, geospatial operations within aggregation pipelines may include calculating distances, areas, and/or intersections.

Geospatial Data Import/Export: MongoDB provides tools and utilities for importing and exporting geospatial data in various formats, such as GeoJSON. This may facilitate migrating geospatial datasets into MongoDB, and/or exporting data for use in other geospatial applications.

In some embodiments, database 430 may support replica sets. The use of replica sets may provide a degree of automatic failover and data redundancy. In some embodiments, a replica set may comprise multiple MongoDB instances (or nodes) that replicate data across nodes to ensure availability and durability. In the event of a node failure, some embodiments may be configured to automatically promote a secondary node to primary node status, thereby lowering and/or minimizing downtime.

In some embodiments, database 430 may be scaled horizontally by distributing data across multiple nodes in a cluster using sharding. Sharding may comprise partitioning data into smaller subsets (shards) and distributing these shards across multiple servers. Sharding may allow database 430 to handle larger volumes of data and high throughput workloads, by distributing the computational load across multiple nodes.

Some embodiments of system 400 may include an aggregation framework. An aggregation framework may enable to execution of data aggregation operations, including but not limited to grouping, filtering, and transforming data. In some embodiments, system 400 may support parallelism of aggregation operations. For example, some embodiments may support the execution of separate aggregation pipelines on sharded clusters of database 430. Some embodiments may support parallel processing on a single node.

In embodiments in which database 430 is sharded, the underlying data assets can be partitioned across multiple shards and the aggregation operations can be executed on different shards simultaneously. This parallel processing configuration may significantly improve the overall performance of the aggregation pipeline, particularly as the size of the data set increases.

In embodiments in which the database 430 is implemented on a single node, certain stages of the aggregation pipeline may be executed independently and in parallel. For example, the “match” and “project” stages of the pipeline can operate on different subsets of data, and can be executed on separate CPU codes, leaving to improved processing times.

As noted above, database 430 may provide access to underlying data assets. In some embodiments, data assets may include one or more of event data assets, client data assets, province and territory data assets, and/or precomputed intersection tables.

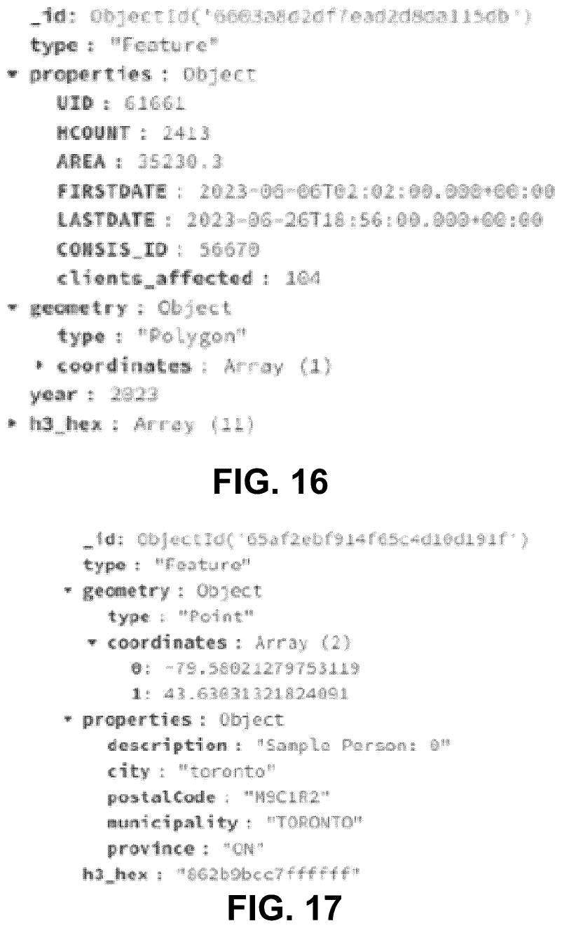

In some embodiments, each type of event is grouped into a separate collection. In some embodiments, collections store event data assets for each event, with the event data asset including data describing the event. In some embodiments, event data assets be one of four types, namely floods fires, Alert Ready alerts, and provincial alerts. FIG. 16 depicts code for an example fire event that could be stored in database 430.

FIG. 17 depicts an example client data asset, namely a client data document. As depicted, the client data object includes location coordinates, H3 indexed geospatial data, city, postal code, municipality, province, and the like.

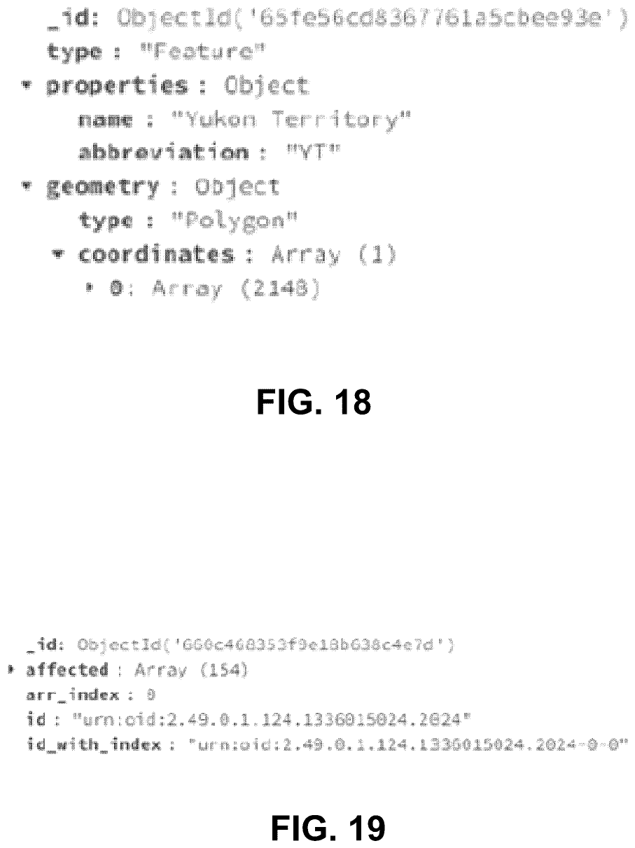

FIG. 18 depicts an example provincial data asset. In some embodiments, each province and territory (or state, prefecture, or the like) may have geospatial boundaries that are used in system 400's geospatial intersections. As depicted in FIG. 18, the data asset describes the Yukon territory in Canada, and contains geospatial data denoting the boundaries.

FIG. 19 depicts an example precomputed intersection table, in accordance with some embodiments. In some embodiments, a precomputed geospatial intersection table may be computed and stored for each event type. In some embodiments, precomputed geospatial intersection tables may contain all the events that are stored in database 430 and the clients that are impacted by that event. In some embodiments, precomputed intersection tables may be updated periodically. In some embodiments, tables may be updated every 15 minutes. As depicted in FIG. 19, the example intersection table includes an “affected” field in which impacted clients are stored.

In some embodiments, event tracking and analysis system 400 may allow end users to assess and manage the impact of climate events on individuals and/or locations within a region. Some embodiments may integrate real-time and historical data on climate events such as fires, floods, and/or other alerts, with an organization's client and branch locations to identify and evaluate risks dynamically.

Some embodiments of event tracking and analysis system 400 may continuously aggregate and process event data from various public sources, and provide real-time insights into events across a region. Some embodiments may be configured to perform geospatial intersections at scale to determine the impact of events (e.g., climate events) on a organization's locations of interest, which may include handling millions of locations and processing billions of intersections with improved performance.

Some embodiments of event tracking and analysis system may provide multi-layered access through a frontend layer 410, a backend layer 420 accessible via API calls, and direct database queries for technical users.

In use, frontend 410 may provide a graphical user interface which includes a map visualization tool that allows the end user to see the geographical spread and severity of various types of events, as well as the impact on individuals and locations of interest. Some embodiments represent significant improvements in the use of technology to monitor climate events, provide a platform to enhance operational effectiveness of an organization, and support client well-being when faced with such events.

In some embodiments, the frontend 410 provides the end user with an interactive visualization map, the ability to filter data appearing on the map, a succinct and visual overview of client impact, disaster identification by address, and bulk client input via CSV upload. Advantageously, some embodiments of frontend 410 may provide improved efficient clustering of data in visualization map 710, exportable/downloadable impact reports for clients, and caching mechanisms which are periodically updated to ensure relative recency of data.

In some embodiments, the backend 420 provides real-time climate data integration, a flexible API for custom data retrieval (e.g., location type, event type, and the like), data retrieval for client-specific events, and data retrieval using CSV files.

Advantageously, some embodiments of backend 420 provided expanded data access through the use of an API such as FastAPI, automated data refreshing and customizable update intervals via the scheduler, and enhanced geospatial analysis with postal codes and H3 indexing.

Some embodiments were tested experimentally using a simulated client data set and data extracted from data sources 442. The computing device used for database 430 had 24 processing cores and 128 gigabytes of Random Access Memory (RAM). The experimental system was able to handle 14 million location intersections, and was able to achieve a response time (taken from the point the a user sends a request, to the point in time at which a response is received by the user) between instant and 1 minute. The “refresh data speed”, referring to the time required by the experimental computing system to perform intersection between newly refreshed event data polygons with 14 million points of interest was in the range of 7 to 10 minutes, which represents a substantial improvement over prior systems which required on the order of 12 hours to determine intersections. The experimental system observed a maximum memory usage of 77 GB of RAM during the peak of geospatial intersection calculations (with a database storing approximately 130 GB of event data and client data).

Some embodiments of the systems and methods disclosed herein may provide near real-time identification and assessment of climate-related risks. As described herein, near real-time may be defined as the ability to provide updated insights within about 5-10 minutes from the moment new event data becomes available in data sources 442, with a client/individual database comprising 14 million entries. It is believed that having data which is current to within the past 5-10 minutes provides sufficient granularity to the end user to allow for timely, informed decision-making in response to emerging climate events. Of course, the amount of time required may increase as the number of events and/or individuals/clients increases.

In some embodiments, the processing time required was significantly reduced through the exploitation of MongoDB capabilities, including aggregation pipelines. The aggregation pipelines were particularly effective in facilitating data processing on documents within collections specific to a particular type of event. The processing time may be further improved through the use of sharding to partition database 430 into different collections, in which parallel computations can be performing using separate computational resources on different shards.

Of course, the above-described embodiments are intended to be illustrative only and in no way limiting. The described embodiments are susceptible to many modifications of form, arrangement of parts, details, and order of operation. The invention is intended to encompass all such modifications within its scope, as defined by the claims.

The following Appendix includes API endpoint documentation for various example API endpoints, in accordance with some embodiments, the entire contents of which are incorporated herein by reference.

What is claimed is:

1. A method of monitoring and visualizing impacts of events, the method comprising:
obtaining a list of entities, each of said entities comprising location data;
obtaining, by one or more workers, at least one event data object corresponding to an event from at least one data source, said at least one event data object comprising an event type and geospatial data defining boundaries of said event;
augmenting said at least one event data object, said augmenting comprising determining, for each of said at least one event data objects, a count of entities affected by said respective event, said determining comprising computing geospatial intersections between said list of entities and said at least one event data object based on said location data and said geospatial data;
storing said at least one event data object as a data asset into one of a plurality of collections of stored events within database, each of said collections corresponding to a distinct event type;
displaying, in a graphical user interface, a map and a form comprising a plurality of form parameters;
sending, via an application programming interface (API), a query to said database based on said form parameters;
receiving, responsive to said query, query results comprising geospatial data representing an area of one or more events, and a respective number of said entities affected by each of said one or more events;
displaying, in said graphical user interface, a rendering of said areas of said one or more events, each of said areas having a color corresponding to said event type, wherein each of said areas is rendered with a border having a color corresponding to a severity of said respective event.

2. The method of claim 1, wherein said augmenting further comprises processing said geospatial data to determine an H3 indexing value.

3. The method of claim 1, wherein said database is partitioned into shards across multiple computing devices.

4. The method of claim 3, wherein each of said shards comprises one of said collections corresponding to said distinct event type.

5. The method of claim 1, wherein said event data objects comprise one or more of fire alerts, flood alerts, provincial alerts, and national alerts.

6. The method of claim 1, further comprising storing said query results in a cache for subsequent retrieval.

7. The method of claim 1, wherein said severity is determined based on a number of entities affected by said respective event.

8. The method of claim 1, wherein said entities comprise one or more of individuals and/or locations of interest.

9. The method of claim 1, further comprising obtaining, by said one or more workers, additional event data objects from said at least one data source, augmenting said additional event data objects, and storing said additional data objects in one or more of said collections.

10. The method of claim 1, wherein said displaying further comprises displaying a plurality of said affected entities on said map using a superclustering technique.

11. A system comprising:
one or more processors;
a non-transitory computer-readable storage medium having stored thereon processor-executable instructions that, when executed by said one or more processors, cause said one or more processors to perform a method of monitoring and visualizing impacts of events, the method comprising:
obtaining a list of entities, each of said entities comprising location data;
obtaining, by one or more workers, at least one event data object corresponding to an event from at least one data source, said at least one event data object comprising an event type and geospatial data defining boundaries of said event;
augmenting said at least one event data object, said augmenting comprising determining, for each of said at least one event data objects, a count of entities affected by said respective event, said determining comprising computing geospatial intersections between said list of entities and said at least one event data object based on said location data and said geospatial data;
storing said at least one event data object as a data asset into one of a plurality of collections of stored events within database, each of said collections corresponding to a distinct event type;
displaying, in a graphical user interface, a map and a form comprising a plurality of form parameters;
sending, via an application programming interface (API), a query to said database based on said form parameters;
receiving, responsive to said query, query results comprising geospatial data representing an area of one or more events, and a respective number of said entities affected by each of said one or more events; and
displaying, in said graphical user interface, a rendering of said areas of said one or more events, each of said areas having a color corresponding to said event type, wherein each of said areas is rendered with a border having a color corresponding to a severity of said respective event.

12. A computer-readable storage medium having stored thereon computer-executable instructions that, when executed by one or more processors, cause the one or more processors to perform a method of monitoring and visualizing impacts of events, the method comprising:
obtaining a list of entities, each of said entities comprising location data;
obtaining, by one or more workers, at least one event data object corresponding to an event from at least one data source, said at least one event data object comprising an event type and geospatial data defining boundaries of said event;
augmenting said at least one event data object, said augmenting comprising determining, for each of said at least one event data objects, a count of entities affected by said respective event, said determining comprising computing geospatial intersections between said list of entities and said at least one event data object based on said location data and said geospatial data;
storing said at least one event data object as a data asset into one of a plurality of collections of stored events within database, each of said collections corresponding to a distinct event type;
displaying, in a graphical user interface, a map and a form comprising a plurality of form parameters;
sending, via an application programming interface (API), a query to said database based on said form parameters;
receiving, responsive to said query, query results comprising geospatial data representing an area of one or more events, and a respective number of said entities affected by each of said one or more events;
displaying, in said graphical user interface, a rendering of said areas of said one or more events, each of said areas having a color corresponding to said event type, wherein each of said areas is rendered with a border having a color corresponding to a severity of said respective event.
